(19) United States
(12) Patent Application Publication
(10) Pub. No.: US 2011/0057923 A1
(43) Pub. Date: Mar. 10, 2011

(54) DATA DRIVER

(75) Inventors: Nobuyuki Yuki, Kanagawa (JP); Junji Tsuruta, Kanagawa (JP)

(73) Assignee: Renesas Electronics Corporation, Kanagawa (JP)

(21) Appl. No.: 12/876,653

(22) Filed: Sep. 7, 2010

(30) Foreign Application Priority Data
Sep. 8, 2009 (JP) 2009-206673

(51) Int. Cl. G09G 5/00; G09G 3/36

(52) U.S. Cl. 345/212; 345/98

(57) ABSTRACT

A data driver includes a gray scale voltage generating circuit includes resistance elements connected in series, and configured to generate a plurality of gray scale voltages; a gray scale voltage selecting circuit configured to select a selection gray scale voltage from among the plurality of gray scale voltages based on a digital signal. The gray scale voltage selecting circuit includes selecting circuits provided with MOS transistors for groups of resistance elements; an ESD (Electro-Static Discharge) protection circuit including P-type protection elements connected between a node for a first power supply voltage VDD and the plurality of nodes, and N-type protection elements connected between a node for a second power supply node to which a second power supply voltage VSS and the plurality of nodes; and a dummy gray scale voltage selecting circuit including a plurality of dummy selecting circuits which includes dummy circuit MOS transistors which are connected between the gray scale voltage generating circuit and the gray scale voltage selecting circuit. The plurality of dummy selecting circuits are always turned on to function as resistances.

### INCORPORATION BY REFERENCE

This application claims a priority on convention based on Japanese Patent Application No. 2009-206673 filed on Sep. 8, 2009. The disclosure thereof is incorporated herein by reference.

### TECHNICAL FIELD

The present invention relates to a data driver applied to a liquid crystal display.

### BACKGROUND ART

FIG. 1 a circuit diagram showing a configuration of a data driver described in Patent Literature 1, as a first conventional data driver. The Patent Literature 1 corresponds to U.S. patent application Ser. No. 11/554,347. The disclosure thereof is incorporated herein by reference.

The first conventional data driver contains a gray scale voltage generating circuit 11 and a gray scale voltage selecting circuit 12.

The gray scale voltage generating circuit 11 generates 2ⁿ (n is an integer of 2 or more) gray scale voltages V0 to V(2ⁿ−1) on the basis of reference voltages Vref0 to VrefM (M is an integer of 2 or more) and supplies them to the gray scale voltage selecting circuit 12. The gray scale voltage selecting circuit 12 receives n digital data signals D1 to Dn together with the gray scale voltages V0 to V(2ⁿ−1). The gray scale voltage selecting circuit 12 selects one of the gray scale voltages VU to V(2ⁿ−1) as a selection gray scale voltage based on the digital data signals D1 to Dn and supplies to a data line of a display panel.

The gray scale voltage generating circuit 11 contains 64 resistance elements connected in series in this example. Although not shown, the 64 resistance elements are referred to as resistance elements RU to R63. A plurality of nodes [TV0], [TV1], [TV2], [TV3], [TV4], [TV5], [TV6], [TV7], [TV8] and [TV9] are set to the series connection of the 64 resistance elements.

Reference voltages Vref0, Vref1, Vref2, Vref3, Vref4, Vref5, Vref6, Vref7, Vref8 and Vref9 are supplied to the nodes [TV0] to [TV9], respectively. The plurality of groups of resistance elements R0 to R7, R8 to R15, R16 to R23, R24 to R31, R32 to R39, R40 to R47, R48 to R55 and R56 to R63 are arranged between the nodes [TV0] and [TV1], [TV1] and [TV2], [TV2] and [TV3], [TV3] and [TV4], [TV5] and [TV6], [TV6] and [TV7], [TV7] and [TV8], and [TV8] and [TV9], respectively. A plurality of gray scale voltages V0 to V63 are generated based on these resistance elements RU to R63′ and the reference voltages Vref0 to Vref9.

Generally, in such a way that the gray scale voltages having positive and negative polarities are supplied to the plurality of data lines, a common voltage VCOM is set to a voltage between the voltage Vref4 and the voltage Vref5 of the voltages Vref0 to Vref9.

The gray scale voltage selecting circuit 12 contains first to n^{th} gray scale voltage selecting stages (for example, refer to the Patent Literatures 1 and 2). A j^{th} (j is an integer satisfying 1≦j≦n gray scale voltage selecting stage selects the (2ⁿ/2^{j}) gray scale voltages from among the (2¹/2^{j-1}) gray scale voltages in response to the j^{th} digital data signal Dj among the n digital data signals D1 to Dn. That is, when j is 1, the 32 gray scale voltages are selected from among the 64 gray scale voltages. When j is 2, the 16 gray scale voltages are selected from the 32 gray scale voltages of the 32, and finally, the one gray scale voltage is selected as the selection gray scale voltage.

The gray scale voltage selecting circuit 12 contains selecting circuits 13-1, 13-2, 13-3 and 13-4 and 14-1, 14-2, 14-3 and 14-4. The selecting circuits 13-1 to 13-4, and 14-1 to 14-4 include MOS transistors provided for the resistance elements R0 to R7, R8 to R15, R16 to R23, R24 to R31, R32 to R39, R40 to R47, R48 to R55 and R56 to R63, respectively. Here, the common voltage VCOM of the pixel is set to a voltage between the voltage Vref4 and the voltage Vref5. Thus, positive polarity selecting circuits 13-1 to 13-4 are provided for the positive polarity side resistance elements R0 to R7, R8 to R15, R16 to R23 and R24 to R31, respectively, and negative polarity selecting circuits 14-1 to 14-4 are provided for negative polarity side resistance elements R32 to R39, R40 to R47, R48 to R55 and R56 to R63, respectively.

The MOS transistors TA, TB, TC and TC included in a group of the positive polarity selecting circuits 13-1 to 13-4 are P-type MOS transistors, respectively. The sizes of the P-type MOS transistors TC and TC included in the positive polarity selecting circuit TC 13-3 and 13-4 are equal to each other.

Also, the MOS transistors TD, TD, TE and TF, included in a group of the negative polarity selecting circuit 14-1 to 14-4 are N-type MOS transistors, respectively. The sizes of the N-type MOS transistors TD and TD included in the group of the negative polarity selecting circuits TD 14-1 and 14-2 are equal to each other.

The sizes of the P-type MOS transistors TA, TB and TC and those of the N-type MOS transistors TD, TE and TF are determined on the basis of the gray scale voltages V0 to V63. Specifically, the P-type MOS transistors TA, TB and TC and the N-type MOS transistors TD, TE and TF are determined on the basis of voltages that are applied between drains and back gates and between sources and back gates. That is, an offset length and a distance between the drain and the back gate are set on the basis of the applied voltage. In this case, the P-type MOS transistors having the highest breakdown voltage are used for the P-type MOS transistors TC among the P-type MOS transistors TA, TB and TC, and the N-type MOS transistors having the highest breakdown voltage are used for the N-type MOS transistors TD among the N-type MOS transistors TD, TE and TF.

In the first conventional data driver, nodes [TV0] to [TV9] (not shown) and a first power source node [VDD] and a second power source node [VSS] are external input nodes. For this reason, a protecting circuit for ESD (Electro-Static Discharge) is required for the first conventional data driver.

FIG. 2 is a circuit diagram showing the configuration of a second conventional data driver in which an ESD protection countermeasure is adopted. FIG. 3 is a conceptual diagram of FIG. 2.

The second conventional data driver further contains an ESD protection circuit 115, as compared with the first conventional data driver.

The ESP protection circuit 115 contains protecting circuits 115-1 to 115-5. The protecting circuits 115-1 to 115-5 contain P-type protection elements PP1 to PP5 and N-type protection elements PN1 to PN5, which serve as diodes, respectively.

The P-type protection element PP1 is connected between a first power supply node [VDD] to which a first power supply voltage VDD higher than the reference voltages Vref0 to Vref9 is supplied, and the nodes [TV0] and [TV1]. The P-type protection element PP2 is connected between the first power supply node [VDD] and the node [TV2]. The P-type protection element PP3 is connected between the first power supply node [VDD] and the nodes [TV3] to [TV6]. The P-type protection element PP4 is connected between the first power supply node [VDD] and the node [TV7]. The P-type protection element PP5 is connected between the first power supply node [VDD] and the nodes [TV8] and [TV9].

The N-type protection element PN1 is connected between a second power supply node [VSS] to which a second power supply voltage VSS lower than the reference voltages Vref0 to Vref9 is supplied and the nodes [TV0] and [TV1]. The N-type protection element PN2 is connected between the second power supply node [VSS] and the node [TV2]. The N-type protection element PN3 is connected between the second power supply node [VSS] and the nodes [TV3] to [TV6]. The N-type protection element PN4 is connected between the second power supply node [VSS] and the node [TV7]. The N-type protection element PN5 is connected between the second power supply node [VSS] and the nodes [TV8] and [TV9].

FIG. 4 shows bar graphs in relation of the breakdown voltages of the N-type MOS transistors TD, TE and TF and the breakdown voltages of the N-type protection elements PN3 to PN5 corresponding to the N-type MOS transistors TD, TE and TF, and the respective used gray scale power supply voltages. The breakdown voltage of the N-type protection element is set to be higher than the power supply voltage and lower than the breakdown voltage of the corresponding MOS transistor. The relation of the breakdown voltages of the P-type MOS transistors TA, TB and TC and the breakdown voltages of the P-type protection elements PN1 to PN3 corresponding to the P-type MOS transistors TA, TB and TC and the respective gray scale power supply voltages are same as in the N-type protection elements. The breakdown voltage of the P-type protection element is set to be higher than the used power supply voltage and lower than the breakdown voltage of the corresponding MOS transistor.

In the second conventional example, it is difficult to decrease the breakdown voltage of the protection element. Moreover, balance of the breakdown voltage of the protection element connected to each of the nodes [TV0] to [TV9] and the breakdown voltage of the MOS transistor corresponding thereto is different. For this reason, in the second conventional data driver, the protection elements of three kinds are required to be prepared for each of the N-type and the P-type protection elements.

### CITATION LIST

[Patent Literature 1]: JP 2007-124428A

[Patent Literature 2]: JP 2001-36407B

### SUMMARY OF THE INVENTION

FIG. 5 shows a circuit configuration of a third conventional data driver that does not use many protection elements. The third conventional data driver contains an ESD protection circuit 15, instead of the ESD protection circuit 115 in the second conventional data driver. The ESD protection circuit 15 contains a protecting circuit 15-1. The protecting circuit 15-1 contains P-type protection elements PP and N-type protection elements PN, which serve as diodes.

The P-type protection elements PP are connected between the first power supply node [VDD] and the nodes [TV0] to [TV9]. The N-type protection elements PN are connected between the second power supply node [VSS] and the nodes [TV0] to [TV9].

Since the ESD protection circuit 15 is provided in the third conventional data driver, the positive polarity selecting circuits 13-1 to 13-4 and the negative polarity selecting circuits 14-1 to 14-4 in the gray scale voltage selecting circuit 12 are connected to the gray scale voltage generating circuit 11. The gray scale voltage selecting circuit 12 is separated into the positive polarity selecting circuits 13-1A to 3-4A and negative polarity selecting circuits 14-1A to 14-4A in the first gray scale voltage selecting stage, and positive polarity selecting circuits 13-1B to 13-4B and negative polarity selecting circuits 14-1B to 14-4B to which remaining digital data signals are supplied.

In this case, the P-type MOS transistors included in the positive polarity selecting circuits 13-1B to 13-4B are the P-type MOS transistors TA, TB, TC and TC, respectively. The N-type MOS transistors included in the negative polarity selecting circuits 14-1B to 14-4B are the N-type MOS transistors TD, TD, TE and TF, respectively.

Also, the P-type MOS transistors included in the positive polarity selecting circuits 13-1A to 13-4A are the P-type MOS transistors TC. That is the P-type MOS transistors TC included in the positive polarity selecting circuits 13-1A to 13-4A are equal in size to the P-type MOS transistors TC included in the positive polarity selecting circuits 13-3B and 13-4B.

Also, the N-type MOS transistors included in the negative polarity selecting circuits 14-1A to 14-4A are the N-type MOS transistors TU. That is, the N-type MOS transistors TD included in the negative polarity selecting circuits 14-1A to 14-4A are equal in size to the N-type MOS transistors TD included in the negative polarity selecting circuits 14-1B and 14-2B.

In this way, in the third conventional data driver, the size of each of the MOS transistors included in the positive polarity selecting circuits 13-1A to 13-4A and the negative polarity selecting circuits 14-1A to 14-4A is increased as compared with the second conventional data driver. For this reason, the size of the gray scale voltage selecting circuit 12 must be increased, in consideration to the sizes of the MOS transistors included in the positive polarity selecting circuits 13-1A to 13-4A and the negative polarity selecting circuits 14-1A to 14-4A. Thus, the entire chip size is increased. Therefore, when the many protection elements are not used, the ESD countermeasure is desired to be carried out without any increase in the size of the gray scale voltage selecting circuit 12.

In an aspect of the present invention, a data driver includes: a gray scale voltage generating circuit including resistance elements connected in series, wherein the resistance elements are grouped into groups, and configured to generate a plurality of gray scale voltages based on the resistance elements and reference voltages which are supplied to a plurality of nodes of the groups of resistance elements; a gray scale voltage selecting circuit configured to select a selection gray scale voltage from among the plurality of gray scale voltages based on a digital signal to supply to a data line of a display panel, wherein the gray scale voltage selecting circuit includes selecting circuits provided with MOS transistors for the groups of resistance elements; an ESD (Electra-Static Discharge) protection circuit including P-type protection elements connected between a first power supply node to which a first power supply voltage higher than the reference voltages is applied and the plurality of nodes, and N-type protection elements connected between a second power supply node to which a second power supply voltage lower than the reference voltages is applied and the plurality of nodes; and a dummy gray scale voltage selecting circuit including a plurality of dummy selecting circuits which includes dummy circuit MOS transistors which are connected between the gray scale voltage generating circuit and the gray scale voltage selecting circuit. The plurality of dummy selecting circuits are always turned on to function as resistances.

In another aspect of the present invention, a liquid crystal display apparatus includes a data driver; and a liquid crystal display panel having a plurality of data lines. The data driver includes: a gray scale voltage generating circuit including resistance elements connected in series, wherein the resistance elements are grouped into groups, and configured to generate a plurality of gray scale voltages based on the resistance elements and reference voltages which are supplied to a plurality of nodes of the groups of resistance elements; a gray scale voltage selecting circuit configured to select a selection gray scale voltage from among the plurality of gray scale voltages based on a digital signal to supply to a data line of a display panel, wherein the gray scale voltage selecting circuit includes selecting circuits provided with MOS transistors for the groups of resistance elements; an ESD (Electro-Static Discharge) protection circuit including P-type protection elements connected between a first power supply node to which a first power supply voltage higher than the reference voltages is applied and the plurality of nodes, and N-type protection elements connected between a second power supply node to which a second power supply voltage lower than the reference voltages is applied and the plurality of nodes; and a dummy gray scale voltage selecting circuit including a plurality of dummy selecting circuits which includes dummy circuit MOS transistors which are connected between the gray scale voltage generating circuit and the gray scale voltage selecting circuit. The plurality of dummy selecting circuits are always turned on to function as resistances.

As mentioned above, a data driver of the present invention contains the above ESD protection element instead of the ESD protection element in the data driver in the second conventional example and further contains the above ESD countermeasure dummy gray scale voltage selecting circuit as compared with the second conventional example. Thus, the MOS transistors in the gray scale voltage selecting circuit have the same size as those of the second conventional data driver. Consequently, according to the data driven of the present invention, the size of the gray scale voltage selecting circuit is not required to be intentionally increased, unlike the data driver in the third conventional example. According to the data driver of the present invention, ESD when the many protection elements are not used, the ESD countermeasure can be carried out without any increase in the size of the gray scale voltage selecting circuit.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 shows a circuit configuration of a first conventional data driver;

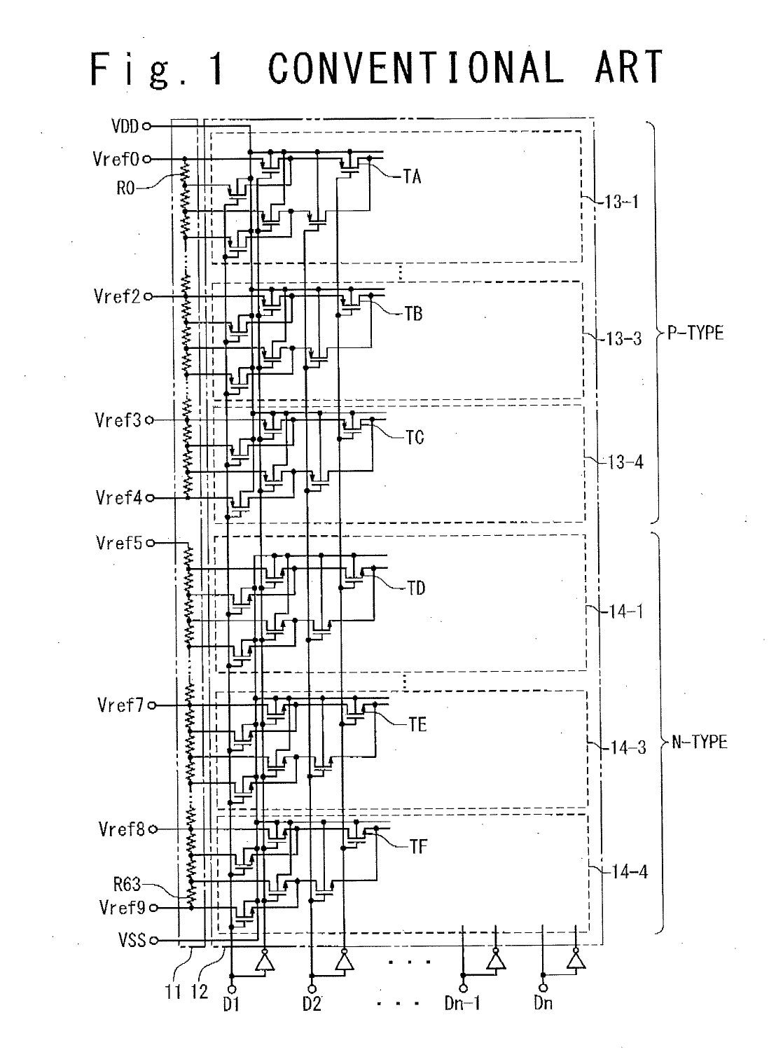

FIG. 2 shows a circuit configuration of a second conventional data driver in which ESD protection countermeasure is adopted;

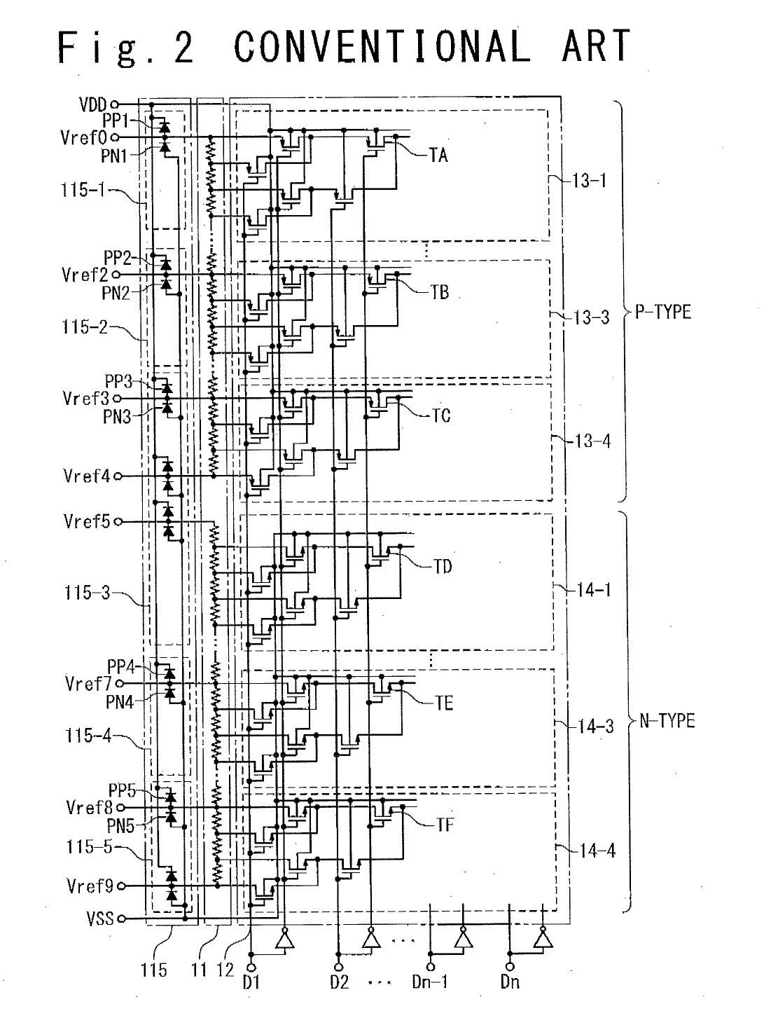

FIG. 3 is the conceptual diagram of FIG. 2;

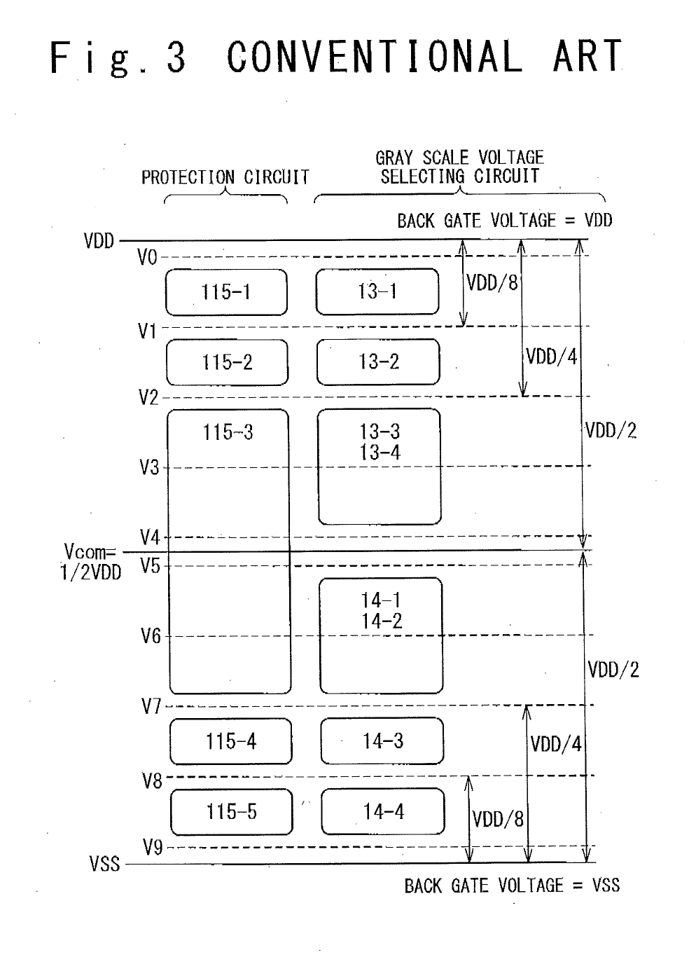

FIG. 4 shows a relation of breakdown voltages of N-type MOS transistors TD, TE and TF, breakdown voltages of N-type protection elements PN 3 to PN5 corresponding to the N-type MOS transistors TD, TE and TF, and the gray scale power supply voltages;

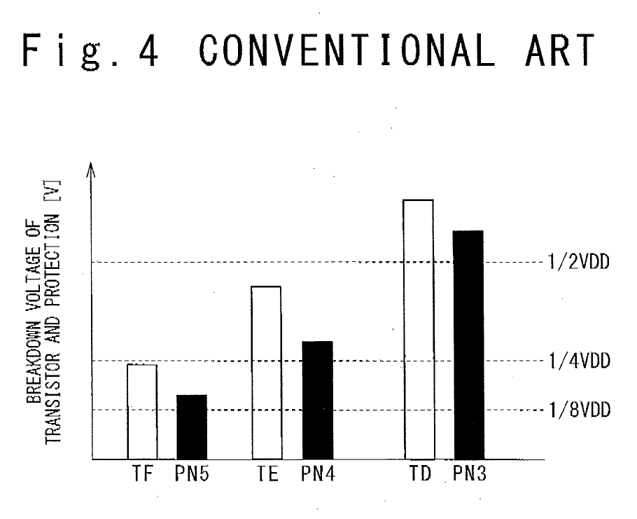

FIG. 5 shows a circuit configuration of a third conventional data driver when many protection elements are not used;

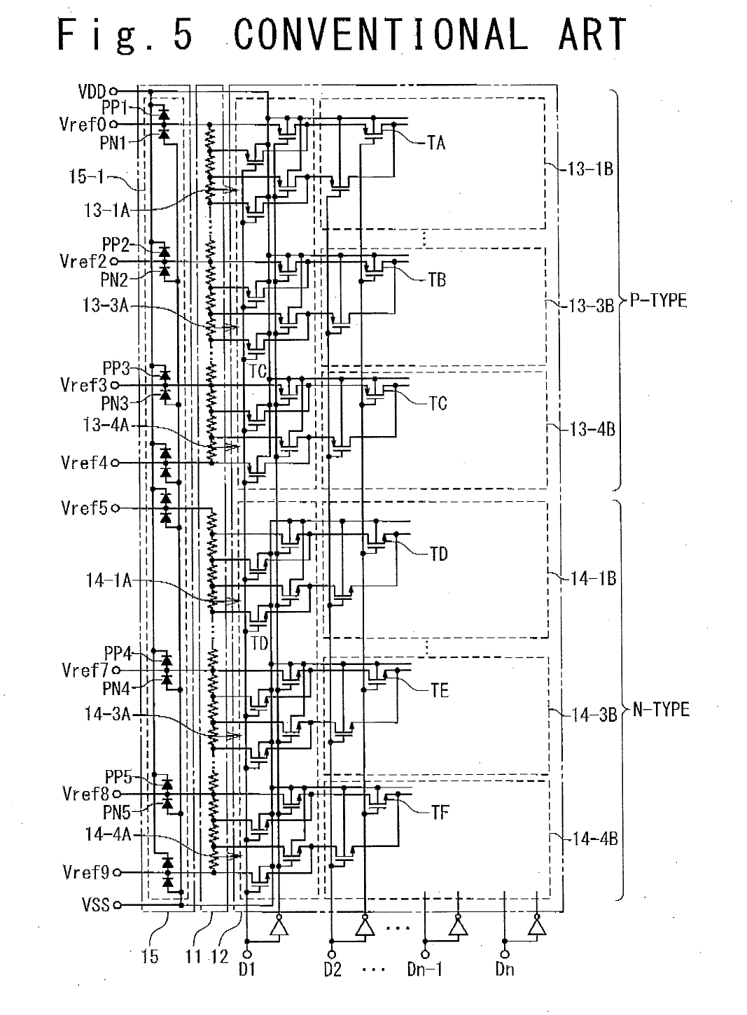

FIG. 6 is a block diagram showing a configuration of a liquid crystal display to which a data driver according to an embodiment of the present invention is applied;

FIG. 7 is a block diagram showing the configuration of the data driver according to the embodiment of the present invention; and

FIG. 8 shows the circuit configuration of the data driver according to the embodiment of the present invention.

### DESCRIPTION OF EMBODIMENTS

Hereinafter, a liquid crystal display apparatus using a data'driver according to the present invention will be described in detail with reference to the attached drawings.

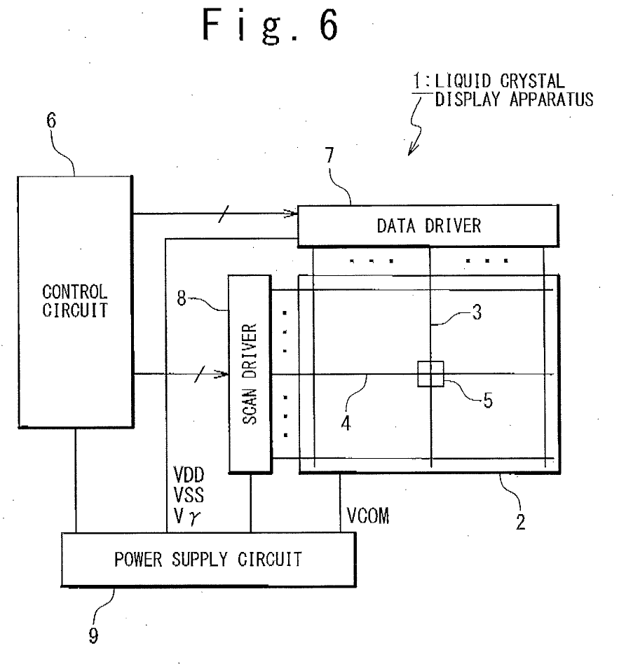

FIG. 6 is a block diagram showing the configuration of the liquid crystal display apparatus 1 to which a data driver 7 according to the present invention is applied.

The liquid crystal display apparatus 1 contains a liquid crystal display panel 2 that has a plurality of pixels 5 arranged in a matrix. In the liquid crystal display panel 2, a plurality of data lines 3 and a plurality of scanning lines 4 are formed to intersect to each other, and the pixels 5 are provided at the respective intersections. The pixel 5 has a TFT (Thin Film Transistor), a liquid crystal and a common electrode. The gate of the TFT is connected to the scanning line 4, and the source or drain of the TFT is connected to the data line 3. One end of a pixel capacitance including the liquid crystal is connected to the source or drain of the TFT, and the other end is connected to the common electrode to which a constant common voltage VCOM is applied.

The liquid crystal display apparatus 1 further contains a control circuit 6, the data driver 7 and a scanning driver 8. The control circuit 6 outputs a scan line control signal to the scan driver 8 and outputs a digital data signal indicating a part of an image, to the data driver 7. The scan driver 8 sequentially drives the plurality of scan lines 4 in accordance with the can line control signal. The data driver 7 supplies analog gray scale voltages to the plurality of data lines 3 based on the digital data signal. Consequently, a gray scale voltage (pixel voltage) is applied to a corresponding one of the plurality of pixels 5 connected to one scan line 4 that is selected from the plurality of scan lines 4. Since the plurality of scan lines 4 are sequentially driven, the image is displayed on the liquid crystal display panel 2.

The liquid crystal display apparatus 1 further contains a power supply circuit 9. The power supply circuit 9 supplies predetermined voltages to the respective circuits. For example, the power supply circuit 9 supplies a first power supply voltage VDD, a second power supply voltage VSS, and a reference voltage V_{γ} to the data driver 7. Also, the power supply circuit 9 supplies the common voltage VCOM to the common electrode of each pixel 5.

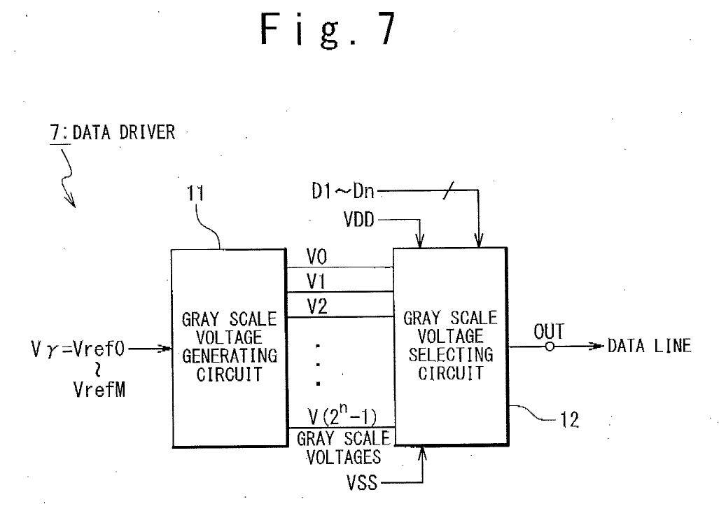

FIG. 7 is a block diagram showing the configuration of the data driver 7 according to the embodiment of the present invention.

The data driver 7 contains a gray scale voltage generating circuit 11 and a gray scale voltage selecting circuit 12.

The reference voltage V_{γ} is supplied from the power supply circuit 9 to the gray scale voltage generating circuit 11. For example, the reference voltage V_{γ} may include a plurality of reference voltages Vref0 to VrefM (M is an integer of 2 or more). The gray scale voltage generating circuit 11 generates 2ⁿ (n is an integer of 2 or more) gray scale voltages V0 to V(2ⁿ−1) on the basis of the reference voltages Vref0 to VrefM and supplies them to the gray scale voltage selecting circuit 12. The gray scale voltage-selecting circuit 12 receives respective n digital data signals D1 to Dn together with the gray scale voltages V0 to V(2ⁿ−1). The gray scale voltage selecting circuit 12 selects one gray scale voltage (as a selection gray scale voltage) from among the gray scale voltages V0 to V(2ⁿ−1) based on the digital data signals D1 to Dn and supplies the selection gray scale voltage to the data line 3.

Hereinafter, it is supposed that M is 9 and a is 6. When n is 6, the display of 64 gray scale levels is carried out.

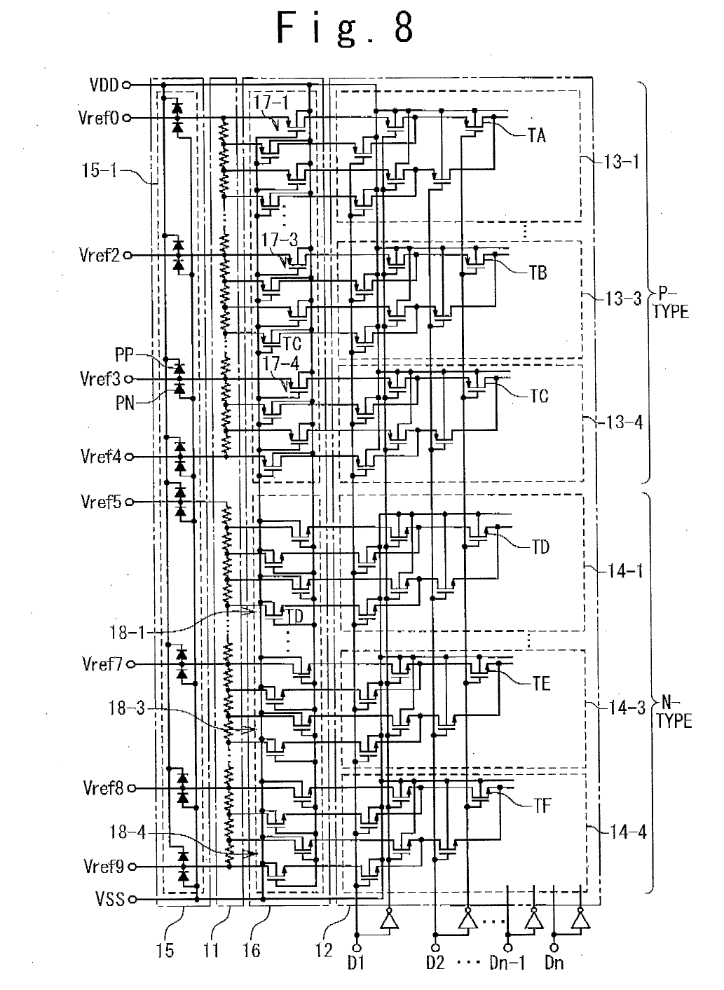

FIG. 8 shows the circuit configuration of the data driver 7 according to the embodiment of the present invention.

The gray scale voltage generating circuit 11 contains 64 resistance elements connected in series. The 64 resistance elements are referred to as resistance elements R0 to R63. It is assumed that reference voltages Vref0, Vref1, Vref2, Vref3, Vref4, Vref5, Vref6, Vref7, Vref8 and Vref9 are supplied to nodes [TV0], [TV1], [TV2], [TV3], [TV4], [TV5], [TV6], [TV7], [TV8] and [TV9], respectively. A plurality of groups of resistance elements R0 to R7, R8 to R15, R16 to R23, R24 to R31, R32 to R39, R40 to R47, R48 to R55 and R56 to R63 are connected between the nodes [TV0] and [TV1], [TV1] and [TV2], [TV2] and [TV3], [TV3] and [TV4], [TV5] and [TV6], [TV6] and [TV7], [TV7] and [TV8], and [TV8] and [TV9], respectively. Thus, a plurality of gray scale voltages V0 to V63 are generated based on the reference voltages Vref0 to Vref9, and the resistance elements R0 to R63.

Generally, in such a way that the gray scale voltage having the positive and negative polarities are supplied to the data line 3, the common voltage VCOM is set to belong between the voltage Vref4 and the voltage Vref5.

The gray scale voltage selecting circuit 12 contains first to n^{th} gray scale voltage selecting stages. A j^{th} (j is an integer satisfying (1≦j≦n)) gray scale voltage selecting stage selects the (2ⁿ/2^{j}) gray scale voltages from the (2ⁿ/2^{j-1}) gray scale voltages in response to the j^{th} digital data signal Dj among then digital signals D1 to Dn. That is, when is 1, the 32 gray scale voltages are selected from the 64 gray scale voltages, and when j is 2, the 16 gray scale voltages are selected from the 32 gray scale voltages. Finally, the one gray scale voltage (as a selection gray scale voltage) is selected.

The gray scale voltage selecting circuit 12 contains selecting circuits 13-1 to 13-4 and 14-1 to 14-4. The selecting circuits 13-1 to 13-4, and 14-1 to 14-4 include MOS transistors that are provided for groups of resistance elements RU to R7, R8 to R15, R16 to R23, R24 to R31, R32 to R39, R40 to R47, R48 to R55 and R56 to R63, respectively.

Here, the common voltage VCOM is set to a voltage between the voltage Vref4 and the voltage Vref5. The positive polarity selecting circuits 13-1 to 13-4 are provided for the resistance element R0 to R7, R8 to R15, R16 to R23 and R24 to R31 and the negative polarity selecting circuits 14-1 to 14-4 are provided for the resistance element R32 to R39, R40 to R47, R48 to R55 and R56 to R63, respectively.

The P-type MOS transistors TA, TB, TC and TC are included in the positive polarity selecting circuits 13-1 to 13-4, respectively. The sizes of the P-type MOS transistors TC included in the positive polarity selecting circuits 13-3 and 13-4 are equal to each other. Also, the N-type MOS transistors TD, TD, TE and TF are included in the negative polarity selecting circuit groups 14-1 to 14-4, respectively. The sizes of the N-type MOS transistors TD included in the negative polarity selecting circuits 14-1 and 14-2 are equal to each other.

The data driver 7 further contains the ESD (Electro-Static Discharge) protection circuit 15 and a dummy gray scale voltage selecting circuit 16 for ESD protection countermeasure.

The ESP protection circuit 15 contains a protecting circuit 15-1. The protecting circuit 15-1 contains P-type protection elements PP and N-type protection elements PN, which are as diodes. The P-type protection elements PP are connected between a first power supply voltage VDD higher than the reference voltages Vref0 to Vref9 and the nodes [TV0] to [TV9], respectively. Also, the N-type protection elements PN are connected between the second power supply voltage VSS lower than the reference voltages Vref0 to Vref9 and the nodes [TV0] to [TV9], respectively.

The dummy gray scale voltage selecting circuit 16 contains dummy selecting circuits 17-1 to 17-4 and 18-1 to 18-4. The dummy selecting circuits 17-1 to 174, and 18-1 to 18-4 include MOS transistors that are connected between the groups of resistance elements R0 to R7, R8 to R15, R16 to R23, R24 to R31, R32 to R39, R40 to R47, R48 to R55 and R56 to R63 and the groups of the selecting circuits 13-1 to 13-4, and 14-1 to 14-4, respectively.

Here, the common voltage VCOM is set to a voltage between the voltage Vref4 and the voltage Vref5. Thus, the positive polarity dummy selecting circuits 17-1 to 17-4 are connected between the groups of resistance elements R0 to R7, RB to R15, R16 to R23 and R24 to R31 and the positive polarity selecting circuits 13-1 to 13-4, respectively. Also, the negative polarity dummy selecting circuits 18-1 to 4 are connected between the groups of resistance elements R32 to R39, R40 to R47, R48 to R55 and R56 to R63 and the negative polarity selecting circuits 14-1, 14-2, 14-3 and 14-4, respectively.

The dummy gray scale voltage selecting circuit 16 functions as the resistance elements because the positive polarity dummy selecting circuits 17-1 to 17-4 and the negative polarity dummy selecting circuits 18-1 to 18-4 are always turned on when they are operated.

The MOS transistors included in the positive polarity dummy selecting circuits 17-1 to 17-4 are the P-type MOS transistors TC, and the MOS transistors included in the negative polarity dummy selecting circuits 18-1 to 18-4 are the N-type MOS transistors TD.

Therefore, in the P-type MOS transistors TC included in the positive polarity dummy selecting circuits 17-1 to 17-4, the second power supply node [VSS] is connected to its gate, and the first power supply node [VDD] is connected to its back gate. In this case, the P-type MOS transistors included in the positive polarity dummy selecting circuits 17-1 to 17-4 are turned on in accordance with the second power supply voltage VSS.

Also, in the N-type MOS transistors TD included in the negative polarity dummy selecting circuits 18-1 to 18-4, the first power supply node [VDD] is connected to its gate, and the second power supply node [VSS] is connected to its back gate. In this case, the N-type MOS transistors included in the negative polarity dummy selecting circuits 18-1 to 18-4 are turned on in accordance with the first power supply voltage VDD.

The sizes of the P-type MOS transistors TA, TB, TC and TC included in the positive polarity selecting circuits 13-1 to 13-4 and the N-type MOS transistors TD, TD, TE and TF included in the negative polarity selecting circuits 14-1 to 14-4 are determined on the basis of the plurality of gray scale voltages V0 to V63. Accordingly, the P-type MOS transistors having the highest breakdown voltage are used for the P-type MOS transistors TC included in the positive polarity selecting circuits 13-3 and 13-4. The N-type MOS transistors having the highest breakdown voltage are used for the N-type MOS transistors TD included in the negative polarity selecting circuits 14-1 and 14-2.

In this case, the size of each of the P-type MOS transistors TC included in the positive polarity dummy selecting circuits 17-1 to 17-4 is equal to the size of each of the P-type MOS transistors TC included in the positive polarity selecting circuits 13-3 and 13-4. Also, the size of each of the N-type MOS transistors TD included in the negative polarity dummy selecting circuits 18-1 to 18-4 is equal to the size of each of the N-type MOS transistors TD included in the negative polarity selecting circuits 14-1 and 14-2.

From the above descriptions, the data driver 7 in the embodiment of the present invention contains the ESD protection circuit 15 instead of the ESD protection circuit 115 in the second conventional data driver and further contains the dummy gray scale voltage selecting circuit 16, as compared with the second conventional data driver. Therefore, the size of the MOS transistor in the gray scale voltage selecting circuit 12 is same as that of the second conventional data driver. Consequently, in the data driver 7 according to the embodiment of the present invention, the size of the gray scale voltage selecting circuit 12 is not required to be intentionally increased, unlike the third conventional data driver. In the data driver 7 according to the embodiment of the present invention, when many protection elements are not used the ESD countermeasure can be attained without any increase in the gray scale voltage selecting circuit 12.

Under the backgrounds of the rapid popularization of a liquid crystal television and a PC monitor, the need enlargement of a liquid crystal display panel that has a large size and a high definition in association with the higher function of a mobile telephone and the like, the market of the liquid crystal driver IC sharply grows, and the cost reduction is advanced. The liquid crystal driver IC, such as the scan driver 8 and the data driver 7 is not exceptional with regard to the attainment of the cost reduction of the liquid crystal display panel. The contraction of the chip size is essential as the means for reducing the cost in the liquid crystal driver IC. In the present invention, the contraction of the chip size is attained without any increase in the risk of the ESD destruction.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A data driver comprising:
a gray scale voltage generating circuit comprising resistance elements connected in series, wherein said resistance elements are grouped into groups, and configured to generate a plurality of gray scale voltages based on said resistance elements and reference voltages which are supplied to a plurality of nodes of said groups of resistance elements;
a gray scale voltage selecting circuit configured to select a selection gray scale voltage from among said plurality of gray scale voltages based on a digital signal to supply to a data line of a display panel, wherein said gray scale voltage selecting circuit comprises selecting circuits provided with MOS transistors for said groups of resistance elements;
an ESD (Electro-Static Discharge) protection circuit comprising p-type protection elements connected between a first power supply node to which a first power supply voltage higher than said reference voltages is applied and said plurality of nodes, and N-type protection elements connected between a second power supply node to which a second power supply voltage lower than said reference voltages is applied and said plurality of nodes; and
a dummy gray scale voltage selecting circuit comprising a plurality of dummy selecting circuits which comprises dummy circuit MOS transistors which are connected between said gray scale voltage generating circuit and said gray scale voltage selecting circuit,
wherein said plurality of dummy selecting circuits are always turned on to function as resistances.

2. The data driver according to claim 1, wherein a size of each of said MOS transistors in said plurality of selecting circuits is determined based on said plurality of gray scale voltages,
wherein said MOS transistors in a first one of said plurality of selecting circuits corresponding to the highest one of said reference voltages have the largest breakdown voltage, and
wherein said dummy circuit MOS transistors have same size as those of said MOS transistors in the first selecting circuit.

3. The data driver according to claim 2, wherein said MOS transistors included in ones on a side of positive polarity of said plurality of dummy selecting circuits are P-type MOS transistors, and
wherein said MOS transistors included in ones on a side of negative polarity of said plurality of dummy selecting circuits are N-type MOS transistors.

4. The data driver according to claim 3, wherein said P-type MOS transistors included in said dummy selecting circuits on the side of positive polarity have gates connected with said second power supply node and back gates connected with said first power supply node, and are turned on based on said second power supply voltage supplied to said second power supply node, and
wherein said N-type MOS transistors included in said dummy selecting circuits on the side of negative polarity have gates connected with said first power supply node and back gates connected with said second power supply node, and are turned on based on said first power supply voltage supplied to said first power supply node.

5. The data driver according to claim 1, wherein said gray scale voltage selecting circuit has first to n^{th} gray scale voltage selecting stages (n is an integer equal to or more than 2), and
wherein a j^{th} gray scale voltage selecting stage (j is an integer satisfying selects (2ⁿ/2^{j}) gray scale voltages from (2ⁿ/2^{j-1}) gray scale voltages based on a j^{th} bit of said digital signal.

6. A liquid crystal display apparatus comprising;
a data driver; and
a liquid crystal display panel having a plurality of data lines,
wherein said data driver comprises:
a gray scale voltage generating circuit comprising resistance elements connected in series, wherein said resistance elements are grouped into groups, and configured to generate a plurality of gray scale voltages based on said resistance elements and reference voltages which are supplied to a plurality of nodes of said groups of resistance elements; and
a gray scale voltage selecting circuit configured to select a selection gray scale voltage from among said plurality of gray scale voltages based on a digital signal to supply to one of said plurality of data lines of said liquid crystal display panel, wherein said gray scale voltage selecting circuit comprises selecting circuits provided with MOS transistors for said groups of resistance elements;
an ESP (Electro-Static Discharge) protection circuit comprising P-type protection elements connected between a first power supply node to which a first power supply voltage higher than said reference voltages is applied and said plurality of nodes, and N-type protection elements connected between a second power supply node to which a second power supply voltage lower than said reference voltages is applied and said plurality of nodes; and
a dummy gray scale voltage selecting circuit comprising a plurality of dummy selecting circuits which comprises dummy circuit MOS transistors which are connected between said gray scale voltage generating circuit and said gray scale voltage selecting circuit,
wherein said plurality of dummy selecting circuits are always turned on to function as resistances.
